(19) United States
(12) Patent Application Publication
(10) Pub. No.: US 2026/0247304 A1
(43) Pub. Date: Aug. 20, 2026

(54) WIRELESS COMMUNICATION SYSTEM, WIRELESS COMMUNICATION METHOD, COMMUNICATION DEVICE AND COMMUNICATION PROGRAM

(71) Applicant: NTT, Inc., Tokyo (JP)

(72) Inventors: Junichi IWATANI, Musashino-shi, Tokyo (JP); Yusuke ASAI, Musashino-shi, Tokyo (JP); Hirantha ABEYSEKERA, Musashino-shi, Tokyo (JP); Akira KISHIDA, Musashino-shi, Tokyo (JP); Yasushi TAKATORI, Musashino-shi, Tokyo (JP)

(73) Assignee: NTT, Inc., Tokyo (JP)

(21) Appl. No.: 19/143,935

(22) PCT Filed: Feb. 2, 2023
(86) PCT No.: PCT/JP2023/003451

§ 371 Date: Jun. 27, 2025

(51) Int. Cl. H04W 52/36; H04W 72/0453; H04W 72/541; H04W 72/563

(52) U.S. Cl. CPC H04W 52/367; H04W 72/0453; H04W 72/541; H04W 72/563

(57) ABSTRACT

This wireless communication system includes a plurality of wireless devices, a relay, and a controller that controls the plurality of wireless device via the relay, and reduces interference between the wireless device and an interfered device. The relay is configured to execute: receiving information of the interfered device from the controller; transmitting, to the controller, an inquiry including a desired frequency received from a target wireless device that is one of the plurality of wireless devices; receiving a response including an available frequency for the target wireless device received from the controller; limiting the response to the target wireless device based on the response targeting the other wireless device received earlier; and transmitting a response corrected based on the limiting to the target wireless device. The wireless device is configured to execute performing wireless communication based on the response received from the relay.

### TECHNICAL FIELD

The present disclosure relates to a wireless communication system, a wireless communication method, a communication device, and a communication program.

### BACKGROUND ART

Automated frequency coordination (AFC) for a wireless LAN is known as a method for controlling a total amount of interference with an interfered system. In the AFC, each wireless device transmits an inquiry message about a radio resource to be used to a control device. The control device responds about a radio resource range that can be used by each wireless device in consideration of a condition of the interfered device.

In addition, in a wireless communication system using the AFC, a relay device may be installed between the control device and the wireless device. The relay device performs message relay, connection, and the like performed between the control device and the wireless device.

### CITATION LIST

### Non Patent Literature

Non Patent Literature 1: Wi-FI Alliance, “Wi-Fi Alliance® furthers Automated Frequency Coordination specification and compliance development to accelerate Wi-Fi 6E”, Jun. 30, 2021, <URL: https://www.wi-fi.org/news-events/newsroom/wi-fi-alliance-furthers-automated-frequency-coordination-specification-and>
Non Patent Literature 2: Wi-Fi Alliance, “AFC System to AFC Device Interface DRAFT Specification”, v0.0.17, P9

### SUMMARY OF INVENTION

### Technical Problem

However, in a system such as the AFC, each wireless device individually responds to the inquiry. Therefore, adjustment to optimize frequency allocation between the wireless devices is not performed. That is, since adjustment for preventing interference between the wireless devices is not performed, there is a problem that throughput of wireless communication is degraded due to mutual interference between the wireless devices.

In order to solve the above-described problem, a first object of the present disclosure is to provide a wireless communication system capable of reducing an amount of interference with an interfered device and improving throughput of wireless communication.

In addition, a second object of the present disclosure is to provide a wireless communication method capable of reducing an amount of interference with an interfered device and improving throughput of wireless communication.

In addition, a third object of the present disclosure is to provide a communication device capable of reducing an amount of interference with an interfered device and improving throughput of wireless communication.

In addition, a fourth object of the present disclosure is to provide a communication program capable of reducing an amount of interference with an interfered device and improving throughput of wireless communication.

### Solution to Problem

A first aspect of the present disclosure is preferably a wireless communication system including: a plurality of wireless devices; a relay device; and a control device that controls the plurality of wireless devices via the relay device, the wireless communication system reducing interference between the wireless device and an interfered device, in which the relay device is configured to execute processing of receiving information of the interfered device from the control device, processing of transmitting, to the control device, an inquiry including a desired frequency received from a target wireless device that is one of the plurality of wireless devices, processing of receiving a response including an available frequency for the target wireless device received from the control device, limitation processing of limiting the response to the target wireless device based on the response targeting the other wireless device received earlier, and processing of transmitting a response corrected based on the limitation processing to the target wireless device, and the wireless device is configured to execute processing of performing wireless communication based on the response received from the relay device.

A second aspect of the present disclosure is preferably a wireless communication method executed by a wireless communication system that includes a plurality of wireless devices, a relay device, and a control device that controls the plurality of wireless devices via the relay device and reduces interference between the wireless device and an interfered device, the wireless communication method is configured to execute: receiving information of the interfered device from the control device; transmitting, to the control device, an inquiry including a desired frequency received from a target wireless device that is one of the plurality of wireless devices; receiving a response including an available frequency for the target wireless device received from the control device; limiting the response to the target wireless device based on the response targeting the other wireless device received earlier; transmitting a response corrected based on the limitation to the target wireless device; and performing wireless communication based on the corrected response.

A third aspect of the present disclosure is preferably a communication device included in a wireless communication system that includes a plurality of wireless devices and a control device that controls the plurality of wireless devices and reduces interference between the plurality of wireless devices and an interfered device, the communication device is configured to execute: processing of receiving information of the interfered device from the control device; processing of transmitting, to the control device, an inquiry including a desired frequency received from a target wireless device that is one of the plurality of wireless devices; processing of receiving a response including an available frequency for the target wireless device received from the control device; limitation processing of limiting the response to the target wireless device based on the response targeting the other wireless device received earlier; and processing of transmitting a response corrected based on the limitation processing to the target wireless device.

A fourth aspect of the present disclosure is preferably a communication program to be executed by a communication device included in a wireless communication system that includes a plurality of wireless devices and a control device that controls the plurality of wireless devices and reduces interference between the plurality of wireless devices and an interfered device, the communication program including a program for causing a computer to execute: processing of receiving information of the interfered device from the control device; processing of transmitting, to the control device, an inquiry including a desired frequency received from a target wireless device that is one of the plurality of wireless devices; processing of receiving a response including an available frequency for the target wireless device received from the control device; limitation processing of limiting the response to the target wireless device based on the response targeting the other wireless device received earlier; and processing of transmitting a response corrected based on the limitation processing to the target wireless device.

### Advantageous Effects of Invention

According to the first to fourth aspects of the present disclosure, it is possible to reduce an amount of interference with the interfered device and improve throughput of wireless communication.

### BRIEF DESCRIPTION OF DRAWINGS

FIG. 1 is a diagram illustrating a conventional AFC system.

FIG. 2 is a diagram illustrating an AFC system according to a first embodiment of the present disclosure.

FIG. 3 is a diagram illustrating an inquiry and a response performed by the AFC system according to the first embodiment of the present disclosure.

FIG. 4 is a diagram illustrating a hardware configuration of a relay device according to the first embodiment of the present disclosure.

FIG. 5 is a diagram illustrating an inquiry and a response performed by an AFC system according to a second embodiment of the present disclosure.

FIG. 6 is a diagram illustrating a processing example of a relay device according to the second embodiment of the present disclosure.

FIG. 7 is a flowchart illustrating processing of updating an allowable frequency, a priority frequency, and allowable transmission power of a wireless device in the relay device according to the second embodiment of the present disclosure.

FIG. 8 is a diagram illustrating an inquiry and a response performed by an AFC system according to a third embodiment of the present disclosure.

### DESCRIPTION OF EMBODIMENTS

### First Embodiment

### [Conventional AFC System]

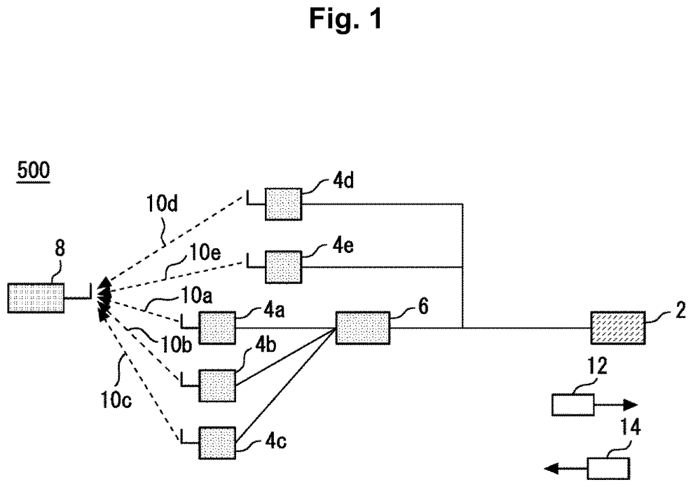

Prior to description of a first embodiment, a conventional AFC system will be described. FIG. 1 is a diagram illustrating the conventional AFC system. An AFC system 500 includes a control device 2. The control device 2 controls wireless devices 4a to 4e.

In addition, the AFC system 500 includes a relay device 6. The relay device 6 performs message relay, connection, and the like between the control device 2 and the wireless devices 4a to 4e.

In addition, the AFC system 500 includes an interfered device 8. The present disclosure is directed to a situation in which the interfered device 8 and the wireless devices 4a to 4e share the same frequency band. That is, interference 10a to 10e may occur between the wireless devices 4a to 4e and the interfered device 8. The AFC system 500 is a system that reduces this.

A method for controlling an amount of interference with an interfered system performed by the AFC system 500 will be described. First, the control device 2 receives information related to wireless communication of the interfered device 8 in advance. Examples of the information received here include position information, a used frequency, and an allowable interference amount of the interfered device 8.

Next, the wireless devices 4a to 4e perform an inquiry 12 to the control device 2. Examples of information included in the inquiry 12 include a position of the wireless device, a desired frequency, and transmission power at each frequency. Note that, when the wireless device is fixed, the position information may be registered in the control device in advance. Further, in the AFC system 500, the relay device 6 relays the information of the wireless devices 4a to 4c.

The control device 2 receives the inquiry 12. Then, based on the information about the wireless communication of the interfered device 8 and the inquiry 12, a frequency range and transmission power that can be used by each wireless device are derived. Further, the derived content is transmitted to the wireless devices 4a to 4e as a response 14. Examples of information included in the response 14 include availability of a frequency, and a frequency range and power which are available.

The wireless devices 4a to 4e receive the response 14 and perform wireless communication based on the response 14. As a result, since the frequency range and the power used by each wireless device for wireless communication are limited, the amount of interference with the interfered system can be controlled.

However, in this method, each wireless device individually responds to the inquiry. Therefore, adjustment to optimize frequency allocation between the wireless devices is not performed. That is, since adjustment for preventing interference between the wireless devices is not performed, there is a possibility that throughput of wireless communication is degraded due to mutual interference between the wireless devices. In addition, there is also a possibility that the interferences 10a to 10e are biased to a specific frequency. The present disclosure solves these problems.

### [AFC System According to First Embodiment]

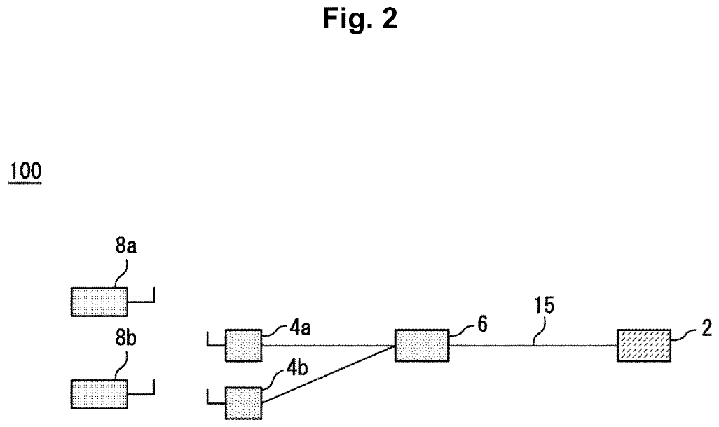

The first embodiment will be described. FIG. 2 is a diagram illustrating an AFC system according to the first embodiment of the present disclosure. An AFC system 100 includes a control device 2. The control device 2 is connected to a relay device 6 via a public network 15. The relay device 6 is connected to wireless devices 4a and 4b. In addition, the AFC system 100 includes interfered devices 8a and 8b.

In the present embodiment, content of a response from the control device 2 to the wireless devices 4a and 4b is limited by the relay device 6. At that time, a message of a wireless device that has made an inquiry or a response earlier is referred to, frequency overlapping is avoided, or transmission power is reduced in a case of the same frequency. As a result, by reducing interference between the wireless devices, it is possible to improve throughput and reduce an amount of interference with the interfered device.

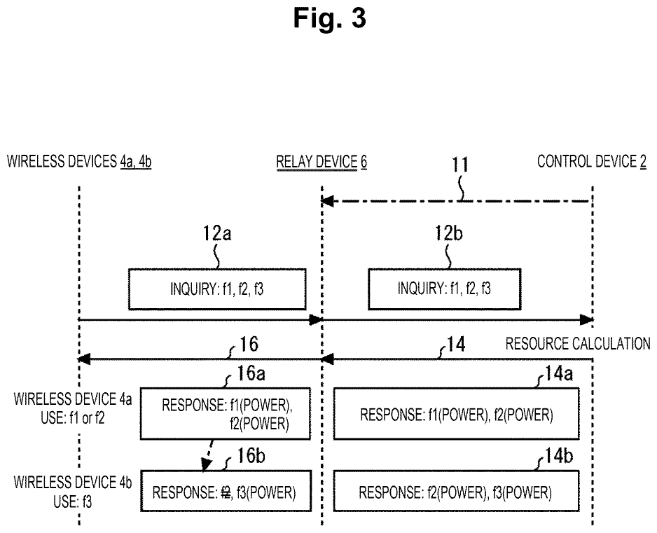

FIG. 3 is a diagram illustrating an inquiry and a response performed by the AFC system according to the first embodiment of the present disclosure. First, the control device 2 transmits information 11 on each interfered device to the relay device 6 in advance. Here, examples of the information to be transmitted include position information, used frequencies, and allowable interference amounts of the interfered devices 8a and 8b.

Next, the wireless devices 4a and 4b transmit an inquiry 12a directed to the control device 2 to the relay device 6. Examples of information included in the inquiry 12a include positions of the wireless devices, desired frequencies, and transmission power at each frequency. Here, f1, f2, and f3 are queried as the desired frequencies. The relay device 6 relays the inquiry 12a and transmits an inquiry 12b having the same content to the control device 2.

The control device 2 receives the inquiry 12b. Then, a frequency range and transmission power that can be used by each wireless device are derived based on the information 11 and the inquiry 12b. Then, the derived content is transmitted to the relay device 6 as a response 14. Examples of information included in the response 14 include availability of a frequency, and a frequency range and power which are available.

Here, an example is shown in which the response 14 includes a response 14a for the wireless device 4a and a response 14b for the wireless device 4b. The response 14a includes information on the available frequencies f1 and f2 and their available power. The response 14b includes information on available frequencies f2 and f3 and their available power.

Upon receiving the response 14, the relay device 6 limits content thereof. At that time, a message of a wireless device that has made a response earlier is referred to, frequency overlapping is avoided, or transmission power is reduced in a case of the same frequency. Then, a response 16 with the limited content is transmitted to the wireless devices 4a and 4b. Note that, here, an example is illustrated in which the response 16 includes a response 16a for the wireless device 4a and a response 16b for the wireless device 4b.

For example, in a case where the response 14a is received first, content of the response 14a is not limited, and is transmitted to the wireless device 4a as the response 16a. As a result, the frequencies f1 and f2 can be used in the wireless device 4a.

For the subsequently received response 14b, content overlapping with the previously received response 14a is limited. Here, the content of the response 14b is limited such that permission to use the frequency f2 overlapping with the response 14a is canceled and only the frequency f3 is set to the available frequency. Then, the response 16b with the limited content is transmitted to the wireless device 4b. As a result, only the frequency f3 can be used in the wireless device 4b.

Finally, the wireless device performs wireless communication based on the received response. Specifically, the wireless device 4a performs wireless communication based on the response 16a, and the wireless device 4b performs wireless communication based on the response 16b.

As described above, in the present embodiment, the content of the response from the control device to the wireless device is limited by the relay device. By reducing the interference between the wireless devices in this manner, it is possible to reduce an amount of interference with the interfered device and improve throughput of wireless communication.

### [Hardware Configuration of Relay Device According to First Embodiment]

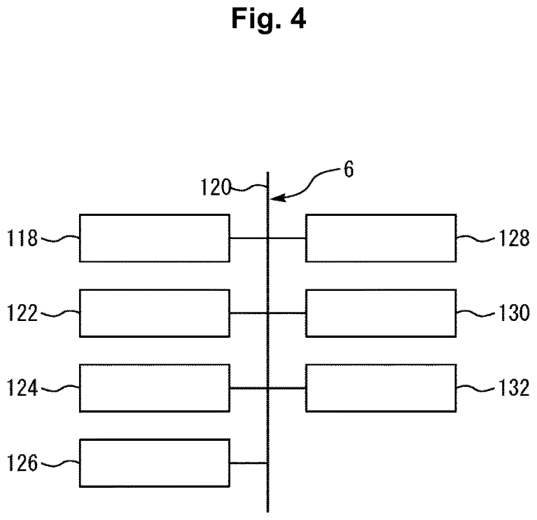

FIG. 4 is a diagram illustrating a hardware configuration of the relay device according to the first embodiment of the present disclosure. The relay device 6 includes a CPU 118. The CPU 118 is connected to a bus line 120. Memory devices such as a ROM 122, a RAM 124, and a storage 126 are connected to the bus line 120. The memory device stores a communication program to be executed by the CPU 118. The CPU 118 executes the communication program, whereby the relay device 6 can implement a function specific to the present embodiment.

A communication interface 128 is also connected to the bus line 120. The relay device 6 implements communication with a network via the communication interface 128. An operation unit 130 and a display unit 132 are further connected to the bus line 120. The operation unit 130 and the display unit 132 function as a user interface for handling the relay device 6.

As described above, the CPU 118 executes the communication program, so that the relay device 6 can implement the function specific to the present embodiment. That is, the relay device 6 can also be implemented by a computer and the program. In addition, the program can be provided by being recorded in a recording medium or through a network.

### Second Embodiment

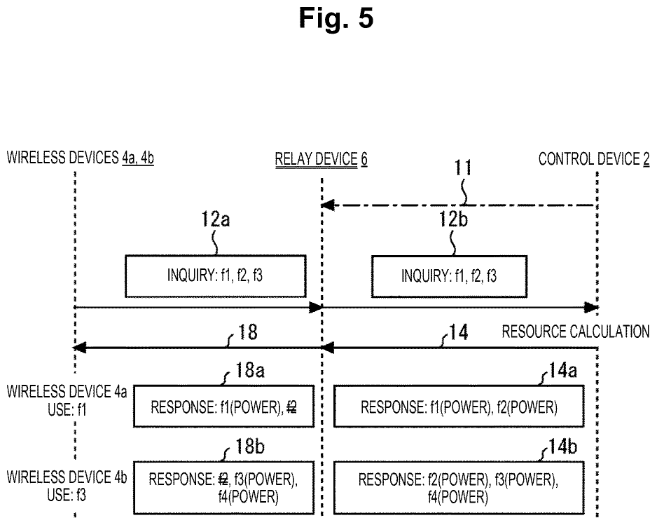

FIG. 5 is a diagram illustrating an inquiry and a response performed by an AFC system according to a second embodiment of the present disclosure. A configuration of the AFC system according to the second embodiment is the same as that of the first embodiment. However, the second embodiment is different from the first embodiment in a method in which a relay device restricts content of a response from a control device.

First, a control device 2 transmits information 11 on each interfered device to a relay device 6 in advance. Next, wireless devices 4a and 4b transmit an inquiry 12a directed to the control device 2 to the relay device 6. Here, f1, f2, and f3 are queried as desired frequencies. The relay device 6 relays the inquiry 12a and transmits an inquiry 12b having the same content to the control device 2.

The control device 2 receives the inquiry 12b. Then, a frequency range and transmission power that can be used by each wireless device are derived based on the information 11 and the inquiry 12b. Then, the derived content is transmitted to the relay device 6 as a response 14.

Here, an example is shown in which the response 14 includes a response 14a for the wireless device 4a and a response 14b for the wireless device 4b. The response 14a includes information on the available frequencies f1 and f2 and their available power. The response 14b includes information on available frequencies f2, f3, and f4 and their available power.

Upon receiving the response 14, the relay device 6 limits content thereof. Here, the relay device 6 determines and holds a priority of a frequency for each wireless device in advance. In addition, information regarding an upper limit of power at each frequency is also determined and held in advance as necessary. Then, the relay device 6 limits the content of the response 14 on the basis of the held information and a response of another inquired wireless device. Specifically, a frequency range is selected so that a frequency to be used does not overlap with that of the other wireless device, or transmission power is reduced to an upper limit value.

Here, the priority of the frequency determined by the relay device 6 may be different for each wireless device. For example, an upper priority frequency band for a specific wireless device may be determined to be a lower priority frequency band for another wireless device. Each wireless device limits the content of the response 14 in accordance with the priority determined in this manner, so that the frequencies used by the wireless devices are less likely to overlap with each other. That is, since interference between the wireless devices can be reduced, throughput of wireless communication can be further improved. Note that the priority may be updated as needed.

Then, a response 18 with limited content is transmitted to the wireless device 4b. Note that, here, an example is illustrated in which the response 18 includes a response 18a for the wireless device 4a and a response 18b for the wireless device 4b.

A specific example will be described below. For example, frequencies that can be used by the wireless device 4a are determined as f1 and f2 in descending order of priority. In addition, frequencies that can be used by the wireless device 4b are determined as f3, f4, and f2 in descending order of priority.

Upon receiving the response 14a, the relay device 6 restricts the content of the response 14a based on the held information. Here, only the frequency f1 is used on the basis of the priority, and permission of the frequency f2 is deleted. Therefore, the response 18a transmitted from the relay device 6 to the wireless device 4a includes only the frequency f1.

Similarly, upon receiving the response 14b, the relay device 6 restricts the content of the response 14b based on the held information. Here, only the frequencies f3 and f4 are used on the basis of the priority, and the permission of the frequency f2 is deleted. Therefore, the response 18b transmitted from the relay device 6 to the wireless device 4b includes only the frequencies f3 and f4. Note that, in this case, since the frequency included in the response 18b does not overlap with the frequency included in the response 18a, there is no need to further limit the content.

Finally, the wireless device performs wireless communication based on the received response. Specifically, the wireless device 4a performs wireless communication based on the response 18a, and the wireless device 4b performs wireless communication based on the response 18b.

As described above, in the present embodiment, the content of the response from the control device to the wireless device is limited by the relay device. By reducing the interference between the wireless devices in this manner, it is possible to reduce an amount of interference with the interfered device and improve throughput of wireless communication.

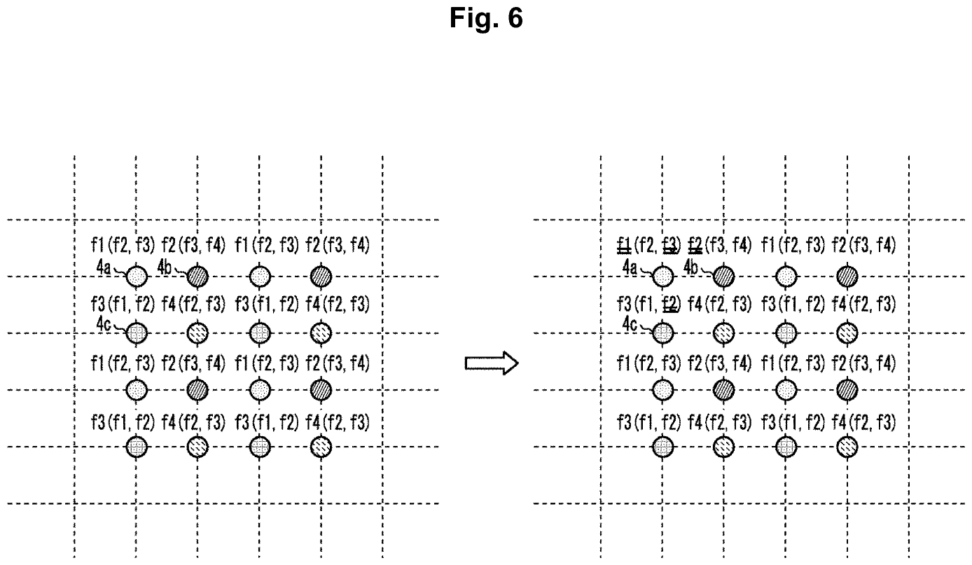

FIG. 6 is a diagram illustrating a processing example of the relay device according to the second embodiment of the present disclosure. The processing example of the relay device 6 according to the present embodiment will be described more specifically with reference to FIG. 6. Note that, here, an example of a case where the number of wireless devices connected to the relay device is 16 will be described. Among the 16 wireless devices, three wireless devices of interest are referred to as wireless devices 4a, 4b, and 4c, respectively.

First, the relay device 6 grasps a position of each wireless device in advance, and determines a priority of a frequency so as to maximize throughput. A left diagram of FIG. 6 illustrates an allowable frequency preset by the relay device in the plurality of wireless devices. Here, the allowable frequency includes a priority frequency and an available frequency. A frequency outside parentheses is the priority frequency, and a frequency inside the parentheses is the available frequency. For example, in the wireless device 4a, the priority frequency is f1, and the available frequencies are f2 and f3. As can be seen from the left diagram of FIG. 6, the relay device 6 reduces interference between the wireless devices by setting adjacent wireless devices to preferentially use different frequencies.

Next, the relay device 6 limits an allowable frequency of a corresponding wireless device on the basis of the response 14 received from the control device 2. In addition, allowable transmission power is also reduced as necessary.

A right diagram of FIG. 6 illustrates a frequency set by the relay device correcting the response 14 in the plurality of wireless devices. Here, an example is illustrated in which a response that enables only the frequency f2 is transmitted from the control device 2 to the wireless device 4a. In this case, the relay device 6 limits the allowable frequency of the wireless device 4a such that the available frequency is only f2. That is, correction is made to delete the priority frequency f1 and the available frequency f3 of the wireless device 4a.

Subsequently, the relay device 6 also limits an allowable frequency or allowable transmission power of a wireless device located around the wireless device whose allowable frequency is limited. Here, the wireless device located around the wireless device 4a is updated so as not to use the frequency f2. That is, correction is made to delete the priority frequency f2 of the wireless device 4b. In addition, correction is made to delete the available frequency f2 of the wireless device 4c.

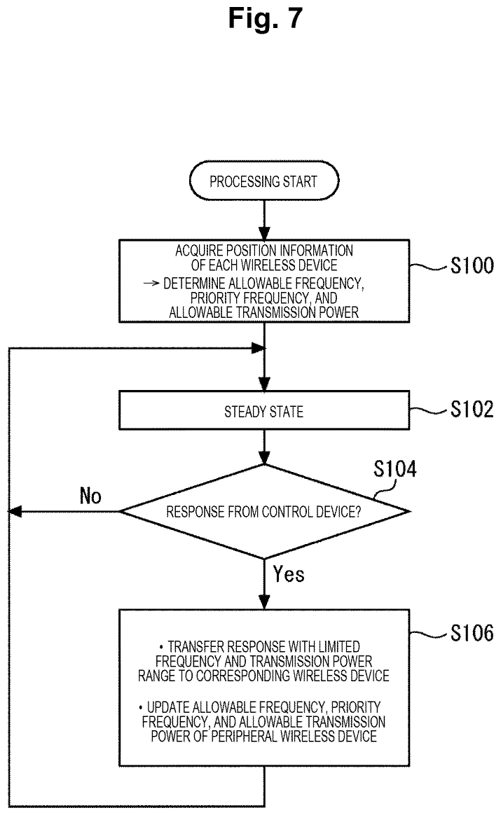

FIG. 7 is a flowchart illustrating processing of updating an allowable frequency, a priority frequency, and allowable transmission power of a wireless device in the relay device according to the second embodiment of the present disclosure. First, in step 100, position information of each wireless device is acquired. The allowable frequency, the priority frequency, and the allowable transmission power of each wireless device are determined based on the position information.

In step 102, a state determined in step 100 is maintained as a steady state. Next, in step 104, it is checked whether there is a response from the control device 2. If there is a response, the processing proceeds to step 106. If there is no response, the processing returns to step 102.

In step 106, a response with limited frequency and transmission power range is transferred to a corresponding wireless device. Further, the allowable frequency, the priority frequency, and the allowable transmission power are updated for a wireless device located around the corresponding wireless device. Then, the processing returns to step 102, and an updated state is set as a new steady state.

As described above, in the present embodiment, the content of the response from the control device to the wireless device is limited by the relay device. By reducing the interference between the wireless devices in this manner, it is possible to reduce an amount of interference with the interfered device and improve throughput of wireless communication.

### Third Embodiment

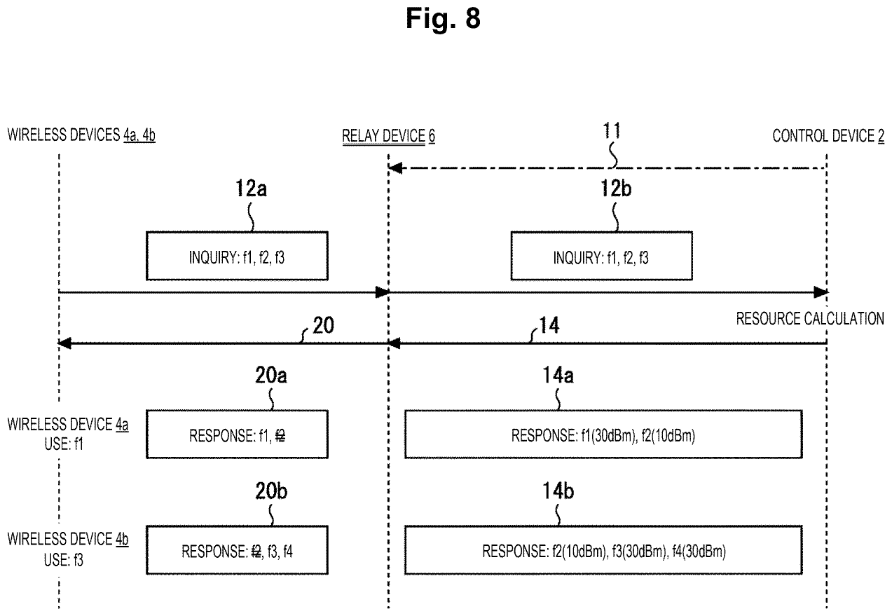

FIG. 8 is a diagram illustrating an inquiry and a response performed by an AFC system according to a third embodiment of the present disclosure. A configuration of the AFC system according to the third embodiment is the same as that of the first embodiment. However, the third embodiment is different from the first embodiment in a method in which a relay device restricts content of a response from a control device.

First, a control device 2 transmits information 11 on each interfered device to a relay device 6 in advance. Next, wireless devices 4a and 4b transmit an inquiry 12a directed to the control device 2 to the relay device 6. Here, f1, f2, and f3 are queried as desired frequencies. The relay device 6 relays the inquiry 12a and transmits an inquiry 12b having the same content to the control device 2.

The control device 2 receives the inquiry 12b. Then, a frequency range and allowable transmission power that can be used by each wireless device are derived based on the information 11 and the inquiry 12b. Then, derived content is transmitted to the relay device 6 as a response 14. Note that the allowable transmission power is determined by the control device on the basis of a relationship with an interfered device.

Here, an example is shown in which the response 14 includes a response 14a for the wireless device 4a and a response 14b for the wireless device 4b. The response 14a includes information on an available frequency f1 and its allowable transmission power of 30 dBm and an available frequency f2 and its allowable transmission power of 10 dBm. The response 14b includes information on the available frequency f2 and its allowable transmission power of 10 dBm, an available frequency f3 and allowable transmission power of 30 dBm, and an available frequency f4 and allowable transmission power of 30 dBm.

Upon receiving the response 14, the relay device 6 limits content thereof. The relay device 6 limits the content of the response 14 by selecting a frequency having large allowable transmission power. Specifically, correction is made to delete other frequencies so as to leave the frequency having large allowable transmission power. Then, a response 20 with limited content is transmitted to the wireless device 4b. Note that, here, an example is illustrated in which the response 20 includes a response 20a for the wireless device 4a and a response 20b for the wireless device 4b.

A specific example will be described below. Upon receiving the response 14a, the relay device 6 restricts the content of the response 14a based on the held information. Here, permission of the frequency f2 is deleted so as to leave the frequency f1 having large allowable transmission power. Therefore, the response 20a transmitted from the relay device 6 to the wireless device 4a includes only the frequency f1.

Similarly, upon receiving the response 14b, the relay device 6 restricts the content of the response 14b based on the held information. Here, the permission of the frequency f2 is deleted so as to leave the frequencies f3 and f4 having large allowable transmission power. Therefore, the response 20b transmitted from the relay device 6 to the wireless device 4b includes only the frequencies f3 and f4. Note that, in this case, since the frequency included in the response 20b does not overlap with the frequency included in the response 20a, there is no need to further limit the content.

Finally, the wireless device performs wireless communication based on the received response. Specifically, the wireless device 4a performs wireless communication based on the response 20a, and the wireless device 4b performs wireless communication based on the response 20b.

As described above, in the present embodiment, the content of the response from the control device to the wireless device is limited by the relay device. By reducing interference between the wireless devices in this manner, it is possible to reduce an amount of interference with the interfered device and improve throughput of wireless communication. In particular, in the present embodiment, since the frequency having large allowable transmission power can be used, it is easier to secure throughput and coverage of wireless communication.

Reference Signs List

| | |
|---|---|
| 2 | Control device |
| 4, 4a, 4b, 4c, 4d, 4e | Wireless device |
| 6 | Relay device |
| 8, 8a, 8b | Interfered device |
| 10a, 10b, 10c, 10d, 10e | Interference |
| 12, 12a, 12b | Inquiry |
| 14, 14a, 14b | Response |
| 16, 16a, 16b | Response |
| 18, 18a, 18b | Response |
| 20, 20a, 20b | Response |

1. A wireless communication system comprising: a plurality of wireless devices; a relay; and a controller that controls the plurality of wireless devices via the relay, the wireless communication system reducing interference between the wireless device and an interfered device, wherein
the relay is configured to execute
receiving information of the interfered device from the controller,
transmitting, to the controller, an inquiry including a desired frequency received from a target wireless device that is one of the plurality of wireless devices,
receiving a response including an available frequency for the target wireless device received from the controller,
limiting the response to the target wireless device based on the response targeting the other wireless device received earlier, and
transmitting a response corrected based on the limiting to the target wireless device, and
the wireless device is configured to execute
performing wireless communication based on the response received from the relay.

2. The wireless communication system according to claim 1, wherein
the relay is configured to further execute holding a priority of frequency that is predetermined for each of the wireless devices, and
the limiting is executed on a basis of the priority of the frequency.

3. The wireless communication system according to claim 2, wherein
the priority of the frequency is determined so that an upper priority frequency band for the specific wireless device is a lower priority frequency band for the other wireless device.

4. The wireless communication system according to claim 1, wherein
the response further includes allowable transmission power determined for each available frequency, and
the limiting is executed on a basis of the allowable transmission power.

5. A wireless communication method executed by a wireless communication system that includes a plurality of wireless devices, a relay, and a controller that controls the plurality of wireless devices via the relay and reduces interference between the wireless device and an interfered device, the wireless communication method is configured to execute:
receiving information of the interfered device from the controller;
transmitting, to the controller, an inquiry including a desired frequency received from a target wireless device that is one of the plurality of wireless devices;
receiving a response including an available frequency for the target wireless device received from the controller;
limiting the response to the target wireless device based on the response targeting the other wireless device received earlier;
transmitting a response corrected based on the limiting to the target wireless device; and
performing wireless communication based on the corrected response.

6. A communication device included in a wireless communication system that includes a plurality of wireless devices and a controller that controls the plurality of wireless devices and reduces interference between the plurality of wireless devices and an interfered device, the communication device is configured to execute:
receiving information of the interfered device from the controller;
transmitting, to the controller, an inquiry including a desired frequency received from a target wireless device that is one of the plurality of wireless devices;
receiving a response including an available frequency for the target wireless device received from the controller;
limiting the response to the target wireless device based on the response targeting the other wireless device received earlier; and
transmitting a response corrected based on the limiting to the target wireless device.

7. A storage medium storing a computer readable communication program configured to cause a computer to execute the communication device according to claim 6.
